(19) United States
(12) Patent Application Publication
(10) Pub. No.: US 2013/0235411 A1
(43) Pub. Date: Sep. 12, 2013

(54) PRINTING APPARATUS, PRINTING APPARATUS CONTROL METHOD, AND STORAGE MEDIUM STORING A PROGRAM

(71) Applicant: CANON KABUSHIKI KAISHA, Tokyo (JP)

(72) Inventor: Yoshitaka Oba, Kawasaki-shi (JP)

(73) Assignee: CANON KABUSHIKI KAISHA, Tokyo (JP)

(21) Appl. No.: 13/768,910

(22) Filed: Feb. 15, 2013

(30) Foreign Application Priority Data
Mar. 9, 2012 (JP) 2012-053678

(51) Int. Cl. G06K 15/00

(52) U.S. Cl. CPC G06K 15/4085
USPC 358/1.14

(57) ABSTRACT

A printing apparatus that conveys printing paper via a conveying path and performs printing stops the printing if a paper jam on the conveying path is detected. If the printing is stopped and it is determined that predetermined paper with sequentiality exists on the conveying path, the printing apparatus waits for an instruction from a user and then resumes the printing after the paper jam is resolved. If the printing is stopped and it is determined that the predetermined paper with sequentiality does not exist on the conveying path, the printing apparatus resumes the printing without waiting for the instruction from the user after the paper jam is resolved.

### BACKGROUND OF THE INVENTION

1. Field of the Invention

The present invention relates to a printing apparatus that performs processing for printing on printing paper based on a print job, a method for controlling a printing apparatus, and a storage medium storing a program.

2. Description of the Related Art

Conventionally, in order to shorten the time (downtime) during which a printing apparatus stops printing, the printing apparatus has a function such that if a paper jam occurs during printing, the printing is automatically resumed after the jammed paper is removed.

Meanwhile, in recent years, there are printing apparatuses that produce a printed matter using predetermined paper with sequentiality, such as tabbed paper having tabs on which headers or titles can be written or paper that is provided with page numbers in advance.

Japanese Patent Laid-Open No. 2002-318509 discloses a printing apparatus that produces printed matter including tabbed paper. The printing apparatus disclosed in Japanese Patent Laid-Open No. 2002-318509 stops printing if a paper jam occurs, and if the print job is not one using tabbed paper, the printing apparatus automatically resumes the printing after the jammed paper is removed. On the other hand, if the print job is one using the tabbed paper, the printing apparatus prompts the user to check the order of tabbed paper in a paper feed tray rather than automatically resuming the printing after the jammed paper is removed. Thereafter, the printing apparatus resumes printing upon accepting a user instruction. It is disclosed that a change in the order of the tabbed paper to be inserted in the printed matter can be thus prevented.

However, in the case of a print job using the predetermined paper with sequentiality, the conventional printing apparatus stops printing and waits to resume the printing after the jammed paper is removed until the user instruction is given, regardless of whether or not the predetermined paper is remaining on a conveying path. For example, if the print job is one for printing using plain paper and tabbed paper, there are times when only plain paper exists on the conveying path. In this case, the order of the tabbed paper is maintained when printing is automatically resumed after the jammed paper is removed, but the conventional printing apparatus waits for resuming of the printing after the jammed paper is removed, resulting in occurrence of downtime.

### SUMMARY OF THE INVENTION

An aspect of the present invention is to eliminate the above-mentioned problems with the conventional technology. The present invention provides a printing apparatus that prevents downtime from occurring at the time of occurrence of a paper jam, a printing apparatus control method, and a storage medium storing a program.

The present invention in its first aspect provides a printing apparatus that conveys printing paper via a conveying path and performs printing, comprising: a detection unit configured to detect a paper jam on the conveying path; a stop unit configured to stop the printing if the paper jam is detected by the detection unit; a determination unit configured to determine whether or not predetermined paper with sequentiality exists on the conveying path; and a control unit configured to wait for an instruction from a user and resume the printing after the paper jam is resolved, if the printing is stopped by the stop unit and it is determined by the determination unit that the predetermined paper with sequentiality exists on the conveying path, and to resume the printing without waiting for the instruction from the user after the paper jam is resolved, if the printing is stopped by the stop unit and it is determined by the determination unit that the predetermined paper with sequentiality does not exist on the conveying path.

The present invention in its second aspect provides a method for controlling a printing apparatus that conveys printing paper via a conveying path and performs printing, comprising: a detection step of detecting a paper jam on the conveying path; a stop step of stopping the printing if the paper jam is detected in the detection step; a determination step of determining whether or not predetermined paper with sequentiality exists on the conveying path; and a control step of waiting for an instruction from a user and resuming the printing after the paper jam is resolved, if the printing is stopped in the stop step and it is determined in the determination step that the predetermined paper with sequentiality exists on the conveying path, and resuming the printing without waiting for the instruction from the user after the paper jam is resolved, if the printing is stopped in the stop step and it is determined in the determination step that the predetermined paper with sequentiality does not exist on the conveying path.

The present invention in its third aspect provides a computer-readable storage medium storing a program for causing a computer to execute: a detection step of detecting a paper jam on a conveying path; a stop step of stopping printing if the paper jam is detected in the detection step; a determination step of determining whether or not predetermined paper with sequentiality exists on the conveying path; and a control step of waiting for an instruction from a user and resuming the printing after the paper jam is resolved, if the printing is stopped in the stop step and it is determined in the determination step that the predetermined paper with sequentiality exists on the conveying path, and resuming the printing without waiting for the instruction from the user after the paper jam is resolved, if the printing is stopped in the stop step and it is determined in the determination step that the predetermined paper with sequentiality does not exist on the conveying path.

According to the present invention, downtime when a paper jam occurs can be suppressed.

Further features of the present invention will become apparent from the following description of exemplary embodiments with reference to the attached drawings.

### BRIEF DESCRIPTION OF THE DRAWINGS

FIG. 1 is a diagram showing an overall configuration of a printing system;

FIG. 2 is a block diagram showing a configuration of an image forming apparatus;

FIG. 3 is a block diagram showing a module configuration of a paper monitoring program;

FIG. 4 is a diagram showing a configuration of the vicinity of a printing paper conveying path within the image forming apparatus;

FIGS. 5A to 5D are diagrams showing exemplary screens for registering printing paper with respect to paper feed trays;

FIG. 6 is a diagram showing an exemplary screen for setting printing paper information;

FIG. 7 is a diagram showing an exemplary content of printing paper registration with respect to the paper feed trays;

FIG. 8 is a diagram for illustrating processing for acquiring remaining printing paper information;

FIG. 9 is a diagram showing exemplary information about printing paper remaining on the convey path;

FIG. 10 is a flowchart showing a procedure of print control processing at the time of occurrence of a paper jam in a first embodiment;

FIG. 11 is a flowchart showing a procedure for acquiring information about paper remaining on the conveying path; and

FIG. 12 is a diagram showing an exemplary screen for prompting a user to check the paper feed trays.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals will be given to the same components, and the description thereof will be omitted.

### First Embodiment

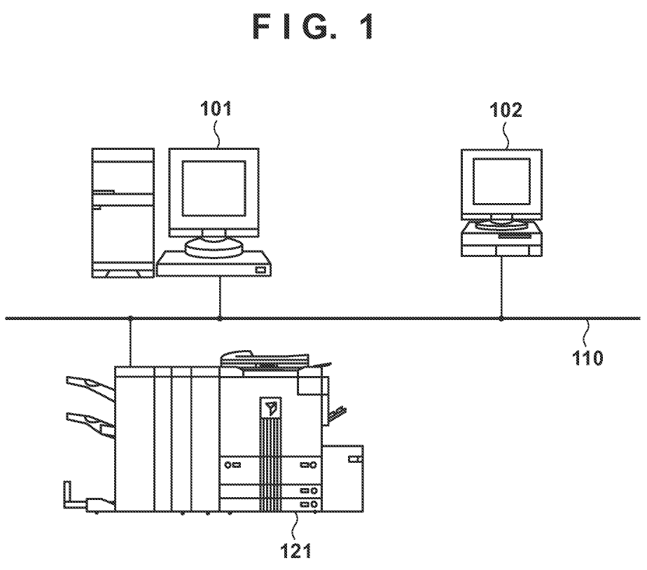

FIG. 1 is a diagram showing an overall configuration of a printing system according to an embodiment of the present invention. The printing system includes client PCs 101 and 102, and an image forming apparatus 121, which is an example of a printing apparatus. The client PCs 101 and 102 and the image forming apparatus 121 are connected via a network 110 so as to be able to communicate with one another. In the present embodiment, the image forming apparatus 121 is a so-called MFP (Multifunction Peripheral) that includes a printing unit, as well as a scanning unit for optically scanning originals, and so on. On the client PC 101 or 102, the user can create image data of an original to be printed, and give a print instruction by transmitting the created image data and print settings to the image forming apparatus 121. In this case, the client PCs 101 and 102 can display a print output state of the image forming apparatus 121 to the user, and the user can perform editing or the like on the original data on the client PCs 101 and 102, based on a print preview display. Although FIG. 1 shows the two client PCs 101 and 102, a configuration may be adopted in which only one client PC is connected to the network 110, or three or more client PCs may be connected to the network 110. Hereinafter, the client PCs 101 and 102 will be referred to simply as “the client PC” when at least one or the other is being described, unless stated otherwise.

The image forming apparatus 121 can receive image data of an original from the client PC, and also read an image on the original by a scanning operation of an original scanning unit 200, which is provided within the image forming apparatus 121, to acquire the original image data. The image forming apparatus 121 performs printing on a printing medium (hereinafter referred to as “printing paper”) according to the settings of a print job, based on the original image data received from the client PC, or the original image data acquired by the original scanning unit 200. In the present embodiment, printing paper includes plain paper, as well as tabbed paper, OHP film, and glossy paper, for example. During printing processing based on the print job, the image forming apparatus 121 performs various types of image processing, such as image correction, file merging, page insertion/deletion, page layout editing, and imposition, on the original image data as needed. After performing image processing on the original image data, the image forming apparatus 121 performs finishing, such as paper folding, saddle-stitch binding, case binding, cutting, enclosing, and collating, on the printed printing paper in accordance with the set content of the print job.

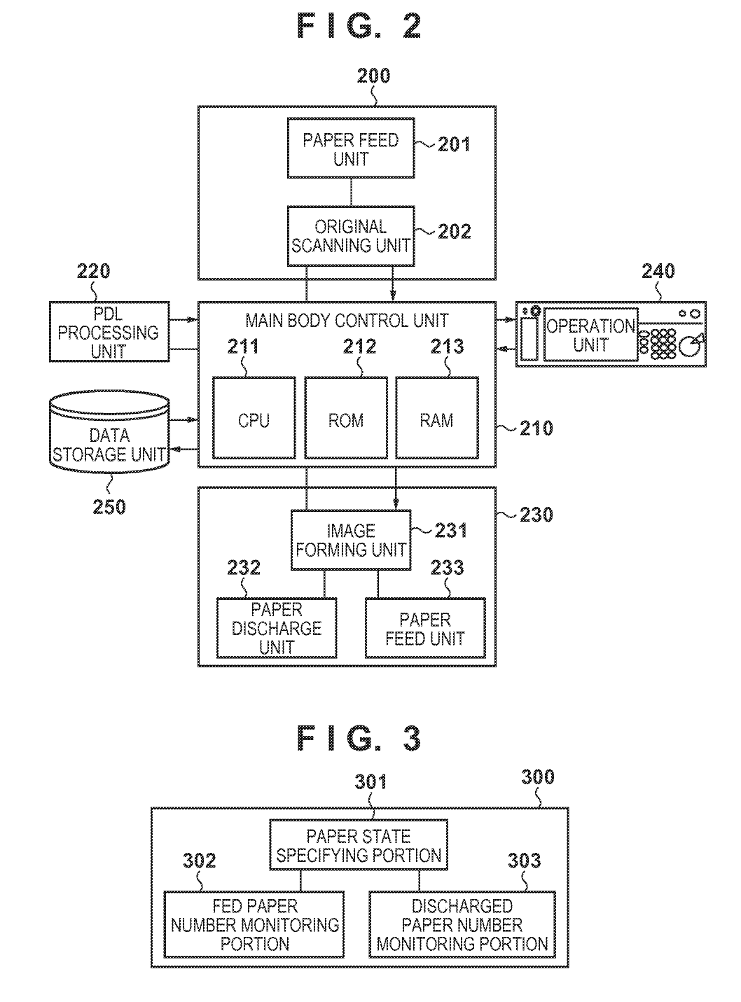

FIG. 2 is a block diagram showing a configuration of the image forming apparatus 121. The image forming apparatus 121 includes the original scanning unit 200, a main body control unit 210, a PDL processing unit 220, an image output unit 230, an operation unit 240, and a data storage unit 250. The original scanning unit 200 includes an original paper feed unit 201 and an original scanning unit 202. The main body control unit 210 includes a CPU 211, a ROM 212, and a RAM 213. The image output unit 230 includes an image forming unit 231, a paper discharge unit 232, and a paper feed unit 233.

The original scanning unit 200 reads out an original that the user placed in a paper feed tray in the original paper feed unit 201 in accordance with a duplicate (copying)/image forming (printing) instruction accepted via the operation unit 240, under the control of the CPU 211. The main body control unit 210 includes the CPU 211 that controls the overall image forming apparatus 121, the ROM 212 that stores a control program for implementing each operation in the present embodiment, and the RAM 213 used as a work memory of the CPU 211. Based on the control program stored in the ROM 212, the CPU 211 controls the original scanning unit 200, the PDL processing unit 220, the image output unit 230, the operation unit 240, the data storage unit 250, and so on, to implement each operation in the present embodiment.

In the present embodiment, the image forming apparatus 121 receives the original in the form of PDL (Page Description Language) data from the client PC. Upon the image forming apparatus 121 receiving the PDL data, the PDL processing unit 220 generates image data to be printed on a printing paper from the PDL data, under the control of the CPU 211.

In the printing processing for printing an image in accordance with the image data received from the original scanning unit 200 or the PDL processing unit 220, the image output unit 230 performs various types of image processing, such as image correction, file merging, page insertion/deletion, and imposition, on the image data under the control of the CPU 211. After performing the image processing, the CPU 211 controls the paper discharge unit 232 and the paper feed unit 233 to convey the printing paper to the image forming unit 231, and controls the image forming unit 231 to perform printing on the printing paper. In addition, the CPU 211 performs finishing, such as paper folding, saddle-stitch binding, case binding, cutting, enclosing, and collating, on the printed printing medium.

The operation unit 240 accepts an instruction from the user via a display unit such as a display. Upon the operation unit 240 accepting the instruction from the user, the CPU 211 stores key information corresponding to the instruction in the RAM 213. The key information is, for example, a selected item on a selection screen displayed on the display unit. The CPU 211 controls the overall image forming apparatus 121 based on the key information stored in the RAM 213. The data storage unit 250 holds system software, the original image data, and so on. The data storage unit 250 also holds information indicating types of printing paper designated as special paper (predetermined paper). In the present embodiment, an instruction from the user is a trigger for resuming of printing that has been stopped due to jamming of a specific kind of printing paper, and this specific kind of printing paper can be specified in advance.

FIG. 3 is a block diagram showing a module configuration of a paper monitoring program stored in the ROM 212. In the present embodiment, each module function shown in FIG. 3 is implemented by the CPU 211 executing the paper monitoring program 300. The paper monitoring program 300 includes a paper state specifying portion 301, a fed paper number monitoring portion 302, and a discharged paper number monitoring portion 303. The fed paper number monitoring portion 302 and the discharged paper number monitoring portion 303 acquire and manage the number of sheets of discharged printing paper that have been discharged from the paper discharge unit 232 and the number of sheets of fed printing paper that have been fed by the paper feed unit 233, based on detection signals from paper feed tray sensors and paper discharge tray sensors, which will be described later. The paper state specifying portion 301 specifies the type of printing paper remaining on the conveying path within the image forming apparatus 121, based on the fed paper number and the discharged paper number provided from the fed paper number monitoring portion 302 and the discharged paper number monitoring portion 303.

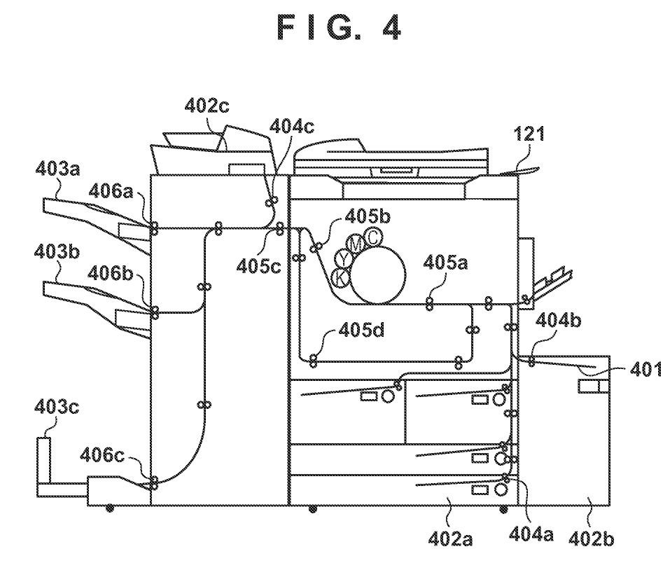

FIG. 4 is a diagram showing a configuration of a printing paper conveying path and therearound within the image forming apparatus 121. A conveying path 401 in the image forming apparatus 121 spans from paper feed trays 402a to 402c provided in the paper feed unit 233 to paper discharge trays 403a to 403c provided in the paper discharge unit 232. The conveying path 401 is provided with the paper feed tray sensors 404a to 404c, paper jam detection sensors 405a to 405d, and the paper discharge tray sensors 406a to 406c. The paper feed tray sensors 404a to 404c detect, respectively, that a printing paper has been fed from the paper feed trays 402a to 402c to the conveying path 401 within the image forming apparatus 121. The paper jam detection sensors 405a to 405d detect a paper jam on the conveying path 401 within the image forming apparatus 121. The paper discharge tray sensors 406a to 406c detect that printing paper has been discharged from the conveying path 401 within the image forming apparatus 121 to the paper discharge trays 403.

Upon the image forming apparatus 121 receiving the print job from the client PC, the CPU 211 controls the paper feed unit 233 so as to feed printing paper from the paper feed trays 402 to the conveying path 401. The paper feed unit 233 feeds printing paper from the paper feed trays 402a to 402c to the conveying path 401. If the CPU 211 receives a detection signal indicating that the paper feed tray sensors 404a to 404c have detected passage of printing paper, the CPU 211 determines that printing paper has been fed correctly from the paper feed tray 402.

The printing paper fed to the conveying path 401 within the image forming apparatus 121 is conveyed to the image forming unit 231. The image forming unit 231 then performs image formation processing on the printing paper under the control of the CPU 211. During this image formation processing, the paper jam detection sensors 405a to 405d monitor the occurrence of jamming of the printing paper that is being conveyed on the conveying path 401. If a predetermined time period has elapsed without printing paper that has passed through one paper jam detection sensor passing through the next paper jam detection sensor, the CPU 211 determines that a paper jam has occurred. Note that the predetermined time period may be decided in accordance with the distance between adjoining paper jam detection sensors. The predetermined time may be set approximately to a value obtained by dividing the distance between the paper jam detection sensors by the conveying speed. If jamming of printing paper has occurred on the conveying path 401, the CPU 211 receives a detection signal indicating that the paper jam detection sensors 405a to 405d have detected a paper jam, and controls the components to stop the printing paper conveying operation. Note that the number and positions of the paper jam detection sensors 405a to 405d are only an example, and is not limited to this example as long as a configuration is employed in which a paper jam occurring on the conveying path can be detected.

Printing paper on which the image formation processing has been performed by the image forming unit 231 is conveyed to the paper discharge unit 232. The CPU 211 controls the paper discharge unit 232 to discharge the printing paper to a predetermined paper discharge tray 403a to 403c in the paper discharge unit 232. If the CPU 211 receives a detection signal indicating that the paper discharge tray sensors 406a to 406c have detected passage of the printing paper, the CPU 211 determines that the printing paper has been discharged correctly from the paper discharge tray 403.

The CPU 211 determines that paper discharge has been completed if it receives a detection signal indicating that printing paper has passed through one of the paper discharge tray sensors 406a to 406c within a predetermined time period. After the printing paper passed through the paper jam detection sensor 405c, if a predetermined time period has elapsed without the printing paper passing through any one of the paper discharge tray sensors 406a to 406c, the CPU 211 determines that a paper jam has occurred, and controls each component to stop the printing paper conveying operation. The predetermined time period may be decided in accordance with the distance from the paper jam detection sensor 405c to each of the paper discharge tray sensors 406a to 406c.

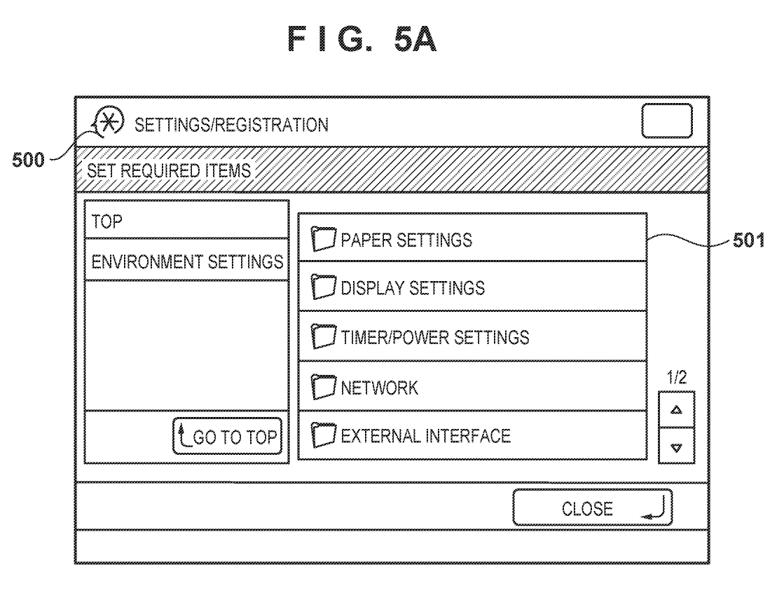

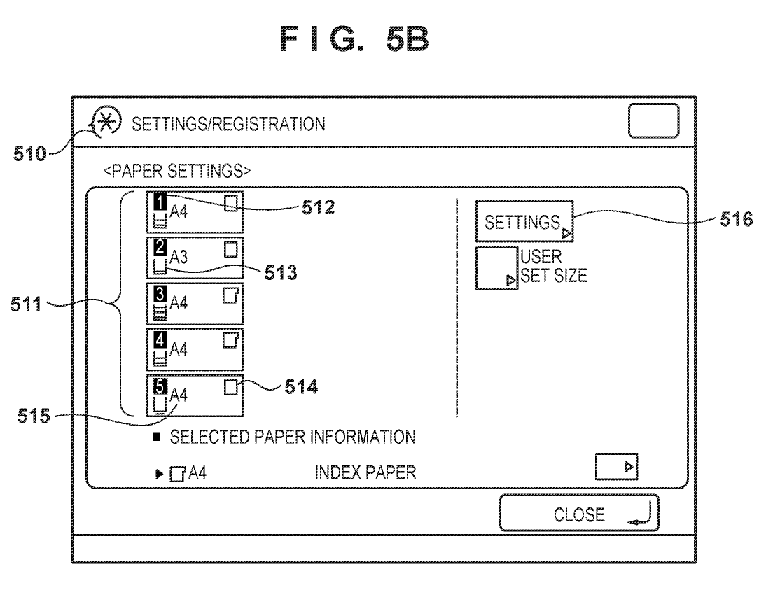

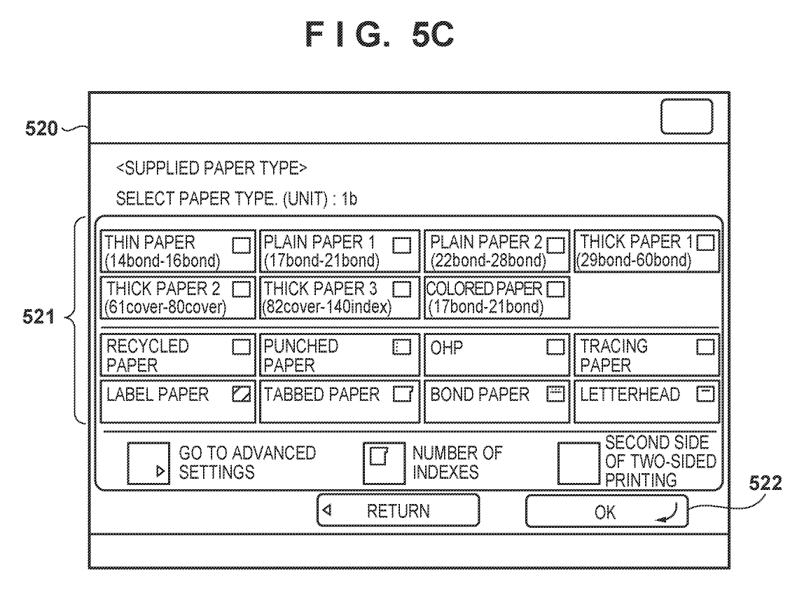

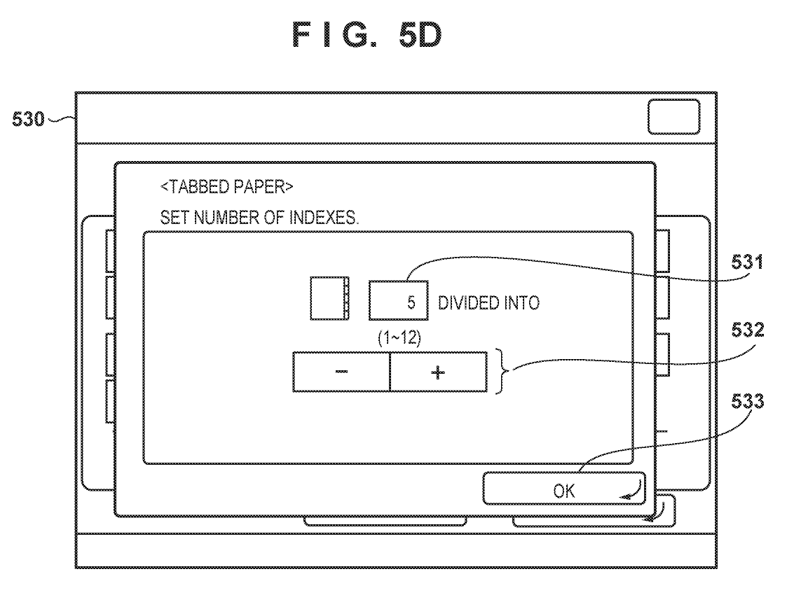

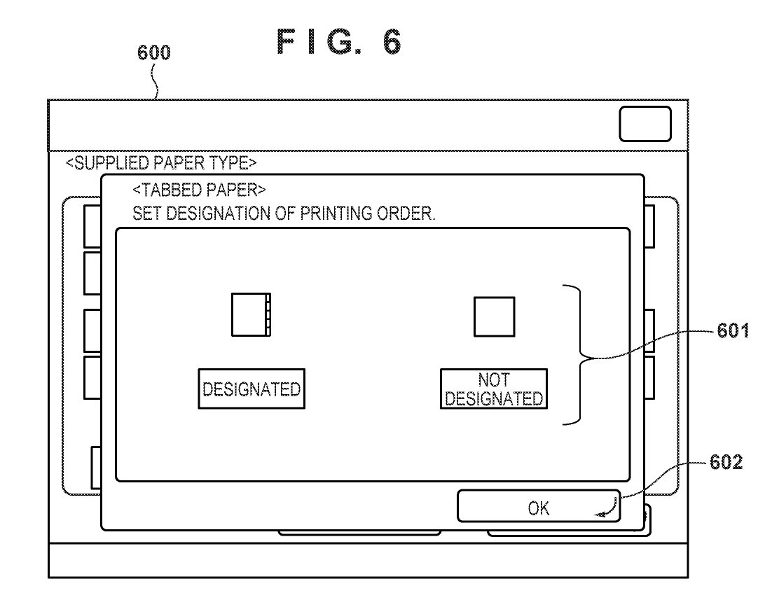

Next, registration of printing paper for the respective paper feed trays in the image forming apparatus 121 by the user will be described with reference to FIGS. 5A to 5D and FIG. 6. FIG. 5A is a diagram showing a printing paper registration screen 500 displayed on the display unit in the operation unit 240. On the registration screen 500, various setting items are organized by group, and a paper setting registration key 501 is displayed that can be selected by the user on the registration screen 500. Upon the paper setting registration key 501 being pressed by the user, the CPU 211 displays a printing paper feed tray selection screen 510 on the display unit in the operation unit 240.

FIG. 5B is a diagram showing the printing paper feed tray selection screen 510. In the paper feed tray selection screen 510, paper feed tray keys 511 indicating the paper feed unit 233, paper feed tray numbers 512, remaining paper amount indications 513 indicating a remaining paper amount in the paper feed trays, paper type indications 514 indicating the types of paper in the paper feed trays, and paper sizes 515 indicating the sizes of paper in the paper feed trays are displayed. The remaining paper amount indications 513 indicating the remaining paper amount in the corresponding paper feed trays and the paper sizes 515 indicating the sizes of paper in the paper feed trays are displayed based on a count value obtained by a placed paper amount sensor, which is provided within each paper feed tray, counting the number of sheets of printing paper when the printing paper is fed into the paper feed trays. Upon one of the paper feed tray key 511 and a setting key 516 being pressed by the user, the CPU 211 starts processing for allocating the paper type to the corresponding paper feed tray. The CPU 211 also displays a paper type registration screen 520 on the display unit in the operation unit 240.

FIG. 5C is a diagram showing the paper type registration screen 520. On the paper type registration screen 520, paper types 521 are displayed. On the paper type registration screen 520, a plurality of paper types that can be registered are displayed. Upon a desired paper type 521 being pressed by the user, the CPU 211 allocates the paper type selected in FIG. 5C to the paper feed tray selected in FIG. 5B. In this example, it is assumed that the user pressed and thus selected “Tabbed paper”. In this case, the CPU 211 displays a screen 530 for setting the tab count on tabbed paper on the display unit in the operation unit 240.

FIG. 5D is a diagram showing the screen 530 for setting a tab count on a tabbed paper. On the screen 530 for setting the a tab count on a tabbed paper, tab count information 531 indicating a user input value, input keys 532, and a setting confirmation key 533 are displayed. The screen 530 for setting a tab count on tabbed paper is a screen for the user to input the tab count on tabbed paper. When the CPU 211 detects the tab count on tabbed paper input by the user using the input keys 532, the CPU 211 stores the tab number as tab count information 531 about the tabbed paper in the RAM 213. Then, upon the setting confirmation key 533 being pressed by the user, the CPU 211 displays a paper information registration setting screen 600 on the display unit in the operation unit 240.

FIG. 6 is a diagram showing the paper information registration setting screen 600. The details of FIG. 6 will be described in a second embodiment.

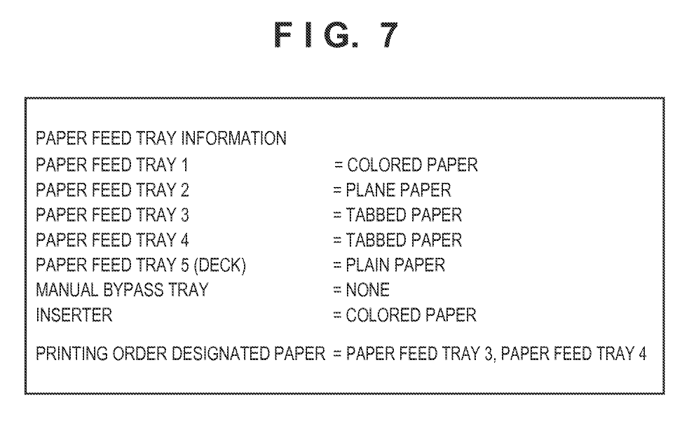

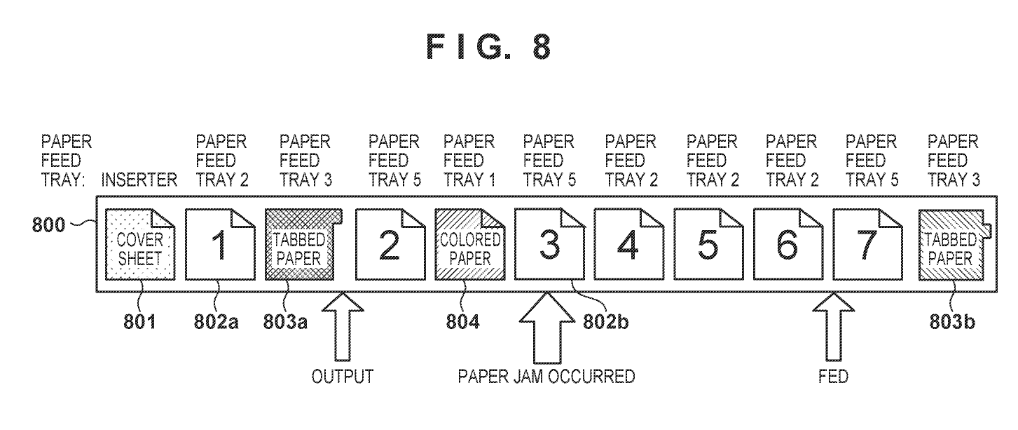

FIG. 7 is a diagram showing an exemplary content set through the registration screens shown in FIGS. 5A to 5D and FIG. 6. As shown in FIG. 7, information about the type of printing medium placed in each paper feed tray and the paper feed trays for which the printing order is designated is registered. The information shown in FIG. 7 is stored in the RAM 213, and read out as needed by the CPU 211, for example.

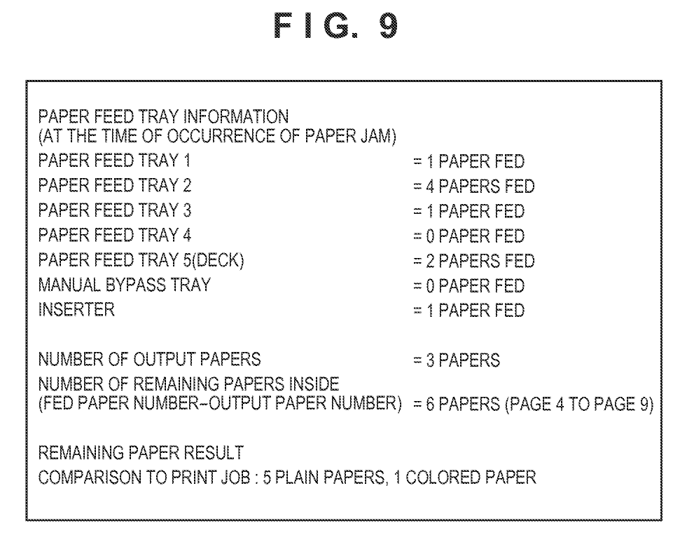

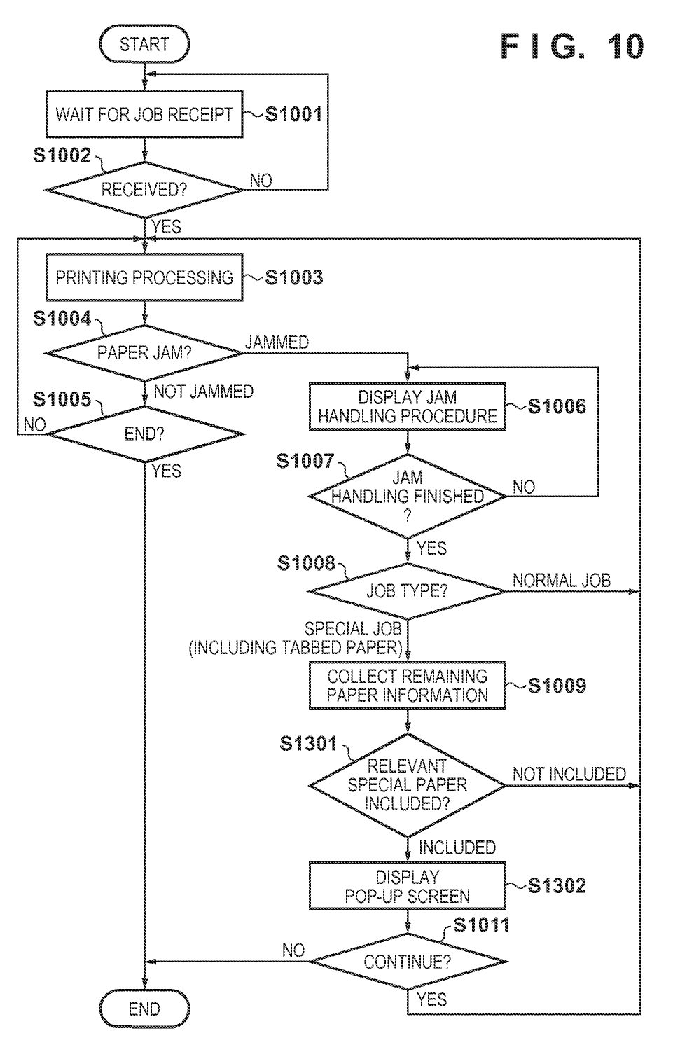

Next, acquisition of information about printing paper remaining within the image forming apparatus 121 when a paper jam has occurred will be described. FIGS. 8 and 9 are diagrams for illustrating processing for acquiring information about printing paper remaining within the image forming apparatus 121 when a paper jam has occurred. Here, as shown in FIG. 8, it is assumed that a print job 800 that is currently targeted for printing is a print job consisting of 11 pages. The paper types of the respective pages of the print job 800 are a cover page 801 that is fed from an inserter in the paper feed unit 233, plain paper 802a, plain paper 802b, tabbed paper 803a, tabbed paper 803b, and colored paper 804.

If a paper jam occurs during printing processing according to the print job 800, the discharged paper number monitoring portion 303 and the fed paper number monitoring portion 302 specify the types of printing paper remaining on the conveying path 401 based on detection signals from the paper feed tray sensors and the paper discharge tray sensors, under the control of the CPU 211. In the present embodiment, the paper state specifying portion 301 determines that no printing paper remains on the conveying path 401 if the number of sheets of printing paper that have already been fed and the number of sheets of printing paper that have already been discharged satisfy expression (1).

Fed paper number−discharged paper number=0 (1)

On the other hand, the paper state specifying portion 301 determines that there is printing paper remaining on the conveying path 401 if expression (2) is satisfied.

Fed paper number−discharged paper number>0 (2)

If it is determined that printing paper remains on the conveying path 401, the CPU 211 specifies a leading page and a trailing page of the printing paper remaining on the conveying path 401, based on the fed paper number and the discharged paper number. A value obtained by subtracting the discharged paper number from the total page number in the current print job is specified as the leading page. A value obtained by subtracting the fed paper number from the total page number in the current print job is specified as the trailing page. The CPU 211 specifies the types of printing paper remaining on the conveying path 401 by comparing the leading page and the trailing page to the types of printing paper of the respective pages set in the print job 800 by the user.

FIG. 9 is a diagram showing exemplary information in which the types of printing paper remaining on the conveying path 401 at the time of occurrence of a paper jam are specified. As shown in FIG. 9, it is clear that the number of sheets of printing paper that have already been fed from the paper feed trays and the inserter is nine. It is also clear that the number of sheets of discharged paper that have been printed and output is three. In other words, based on those two values, the number of sheets of printing paper remaining on the conveying path 401 at the time of occurrence of the paper jam is calculated to be six from page 4 to page 9 in the print job 800. The CPU 211 compares the remaining printing paper to the types of printing paper on the respective pages set in the print job 800 (e.g., FIG. 8), and determines that five sheets of plain paper and one sheet of colored paper remain on the conveying path 401.

A procedure of print control processing at the time of occurrence of a paper jam will be described with reference to FIG. 10. FIG. 10 is a flowchart showing the procedure of the print control processing at the time of occurrence of a paper jam in the present embodiment. The processing shown in FIG. 10 is implemented by the CPU 211 executing the control program stored in the ROM 212, for example. The CPU 211 waits for receipt of a print job from the client PC 101 or 102 (S1001, S1002). Here, upon the image forming apparatus 121 receiving the print job, the CPU 211 controls the PDL processing unit 220 and the image output unit 230 to perform the printing processing on each page with respect to the received print job (S1003). The CPU 211 determines whether or not a paper jam has occurred on the conveying path 401 during the printing processing, based on detection signals from the paper feed tray sensors 404, the paper jam detection sensors 405, and the paper discharge tray sensors 406 (S1004). If it is determined in step S1004 that a paper jam has not occurred, the CPU 211 determines whether or not the printing processing has finished on all pages. Here, if it is determined that the printing processing has finished on all pages, the processing shown in FIG. 10 is ended. On the other hand, if is determined that the printing processing has not finished on all pages, the processing from step S1003 onward is repeated.

If it is determined in step S1004 that a paper jam has occurred, the CPU 211 stops the printing paper conveying operation, and displays a paper jam handling procedure on the display unit in the operation unit 240 (S1006). The paper jam handling procedure is, for example, an illustration of the location where the paper jam has occurred and a procedure for resolving the paper jam. The user can resolve the paper jam by removing the paper remaining on the conveying path 401 in accordance with the paper jam handling procedure. The data for displaying the paper jam handling procedure is stored in advance in the data storage unit 250. Subsequently, the CPU 211 continues to cause the screen of the paper jam handling procedure to be displayed on the operation unit 240 until the user finishes the paper jam handling procedure (S1007). After the paper jam is resolved, the CPU 211 advances the processing to step S1008.

Next, the CPU 211 determines whether or not the print job received in step S1002 is a print job for which the user needs to open and close the paper feed unit 233 to check the printing paper placed in the paper feed trays 402 (S1008). At this time, if the print job is not a print job in which the printing processing is performed using special paper such as tabbed paper set on the screens shown in FIGS. 5A to 5D, the CPU 211 determines that the print job is not a print job for which checking of the printing paper placed on the paper feed unit 233 is necessary. Then, the CPU 211 returns to the printing processing in step S1003, and automatically resumes the stopped printing processing. On the other hand, if the print job is a print job in which the printing processing is performed using special paper such as tabbed paper set on the screens shown in FIGS. 5A to 5D, the CPU 111 determines that the print job is a print job for which checking of the printing paper placed in the paper feed trays is necessary, and advances the processing to step S1009. This is because, in the case of a print job in which the printing processing is performed using the tabbed paper set on the screens of FIGS. 5A to 5D, there is a possibility that the consistency between the tabbed paper that has already been discharged and the tabbed paper that is fed after the printing is resumed cannot be maintained, if the printing is simply resumed after removing the paper on the conveying path 401.

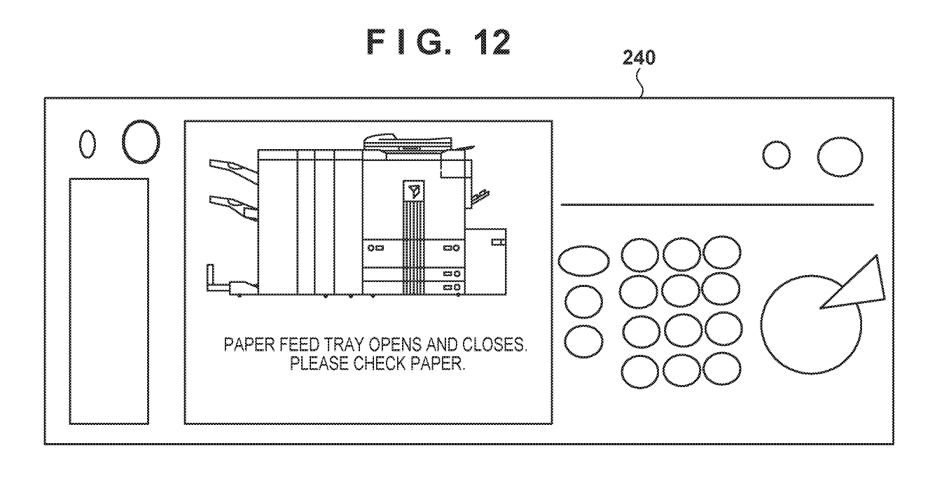

The CPU 211 acquires information about the printing paper that currently remains on the conveying path 401 to facilitate the task of the user checking the paper feed unit 233 (S1009). In the present embodiment, the CPU 211 determines whether or not tabbed paper is included in the paper information acquired in step S1009 (S1301). In other words, the CPU 211 determines whether or not special paper exists on the conveying path 401. Here, if it is determined that tabbed paper is not contained, the CPU 211 returns to the printing processing in step S1003, and resumes the stopped printing processing. On the other hand, if it is determined that tabbed paper is contained, the CPU 211 displays a pop-up screen shown in FIG. 12 on the display unit in the operation unit 240 (S1010). The screen shown in FIG. 12 is a screen for prompting the user to open and close the paper feed tray in which the tabbed paper is placed to check the paper set therein. The user views the screen and arranges the order of the tabbed paper set in the paper feed tray. Specifically, the tabbed paper can be arranged so that the tabbed paper that should come after the tabbed paper that has already been discharged is at the top in the paper feed tray. On the display unit, a button (not shown) for accepting an instruction to resume (continue output) or stop the printing is also displayed. Here, if a resuming instruction from the user is accepted, the CPU 211 returns to the printing processing in step S1003 and resume printing. On the other hand, if a stop instruction is accepted from the user, the CPU 211 stops the printing and ends the processing (S1011).

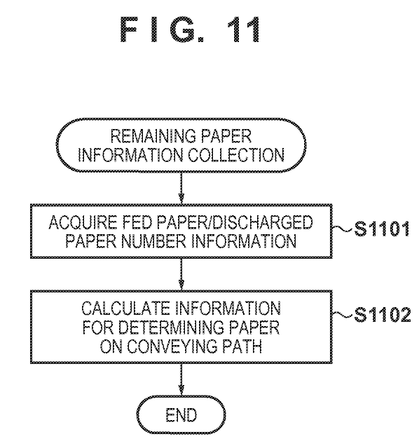

FIG. 11 is a flowchart showing the procedure in S1009 for acquiring information about paper remaining on the conveying path 401, and the procedure in step S1301 for determining whether or not special paper exists. The processing shown in FIG. 11 is implemented by the CPU 211 executing the control program stored in the ROM 212, for example. The CPU 211 controls the fed paper number monitoring portion 302 and the discharged paper number monitoring portion 303 to acquires the number of sheets of fed and discharged paper in the paper feed unit 233 and the paper discharge unit 232 (S1101). The CPU 211 controls the paper state specifying portion 301, compares the acquires number of sheets of fed and discharged paper to the types of the printing paper corresponding to the respective pages designated in the print job, and specifies the types of the printing paper remaining on the conveying path 401 (S1102).

As described above, in the present embodiment, it is determined, at the time of occurrence of a paper jam, whether or not to automatically resume the printing after the paper jam is resolved, based on whether or not tabbed paper is included among the paper remaining on the conveying path 401. Therefore, if tabbed paper is not included among the paper remaining on the conveying path 401, unnecessary downtime can be prevented from occurring.

### Second Embodiment

The first embodiment has been described, taking an example in which it is determined, at the time of occurrence of a paper jam, whether or not to automatically resume printing after the paper jam is resolved, based on whether or not tabbed paper is included among the paper remaining on the conveying path 401.

The special paper with sequentiality is not limited to tabbed paper. For example, paper to which page numbers are provided in advance (paper including plain paper and thick paper) are also categorized as special paper with sequentiality.

In the present embodiment, an example will be described in which, in the case of printing an image on such paper, it is also determined, at the time of occurrence of a paper jam, whether or not to automatically resume printing after the paper jam is resolved, based on whether or not special paper is included among the paper remaining on the conveying path.

In the present embodiment, the user selects one paper type 521 to be registered for the paper feed tray from among the plurality of paper types on the paper type registration screen 520 shown in FIG. 5C. Upon the user selecting one of the paper types 521, the CPU 211 allocates the paper type selected in FIG. 5C to the paper feed tray selected in FIG. 5B. Furthermore, the CPU 211 displays the paper information registration setting screen 600 shown in FIG. 6 on the display unit in the operation unit 240. On the paper information registration setting screen 600, paper printing order designation information selection keys 601 and a setting confirmation key 602 are displayed. The paper information registration setting screen 600 is a screen for the user to set that the type of printing paper set in the paper feed tray is a type with respect to which the printing order has to be considered. If the CPU 211 detects that the user has selected “Designated” with the paper printing order designation information selection key 601, it stores, in the RAM 213, information indicating that the type of the printing paper set in the paper feed tray is a paper type with respect to which the printing order has to be considered. On the other hand, if the CPU 211 detects that the user has selected “Not designated” with the paper printing order designation information selection key 601, it stores, in the RAM 213, information indicating that the type of printing paper that is currently set is a paper type with respect to which the printing order need not be considered. Upon the setting confirmation key 603 being pressed, the CPU 211 ends this screen. Using the screen shown in FIG. 6, the user selects “Designated” when configuring settings for the paper feed tray in which paper that is provided in advance with page numbers is set.

Next, a procedure of print control processing at the time of occurrence of a paper jam will be described with reference to FIGS. 10 and 11. FIG. 10 is a flowchart showing the procedure of the print control processing at the time of occurrence of a paper jam. The processing shown in FIG. 10 is implemented by the CPU 211 executing processing based on the control program stored in the ROM 212, for example.

The processing in the steps other than steps S1008, S1301 and S1302 is the same as that in the first embodiment, and will not be described here in detail.

In step S1008, the CPU 211 determines whether or not the print job received in step S1002 is a print job for which the user needs to open and close the paper feed unit 233 to check the printing paper placed on the paper feed unit 233 (S1008). At this time, if the print job is not a print job for performing the printing processing using the paper that has been designated as printing order designated paper on the screen shown in FIG. 6, the CPU 211 determines that the print job is not a print job for which the printing paper placed in the paper feed trays in the paper feed unit 233 needs to be checked. Then, the CPU 211 returns to the printing processing in step S1003 and automatically resumes the stopped printing processing. On the other hand, if the print job is a print job for performing the printing processing using paper that has been designated as the printing order designated paper, the CPU 211 determines that the print job is a print job for which the printing paper placed in the paper feed trays needs to be checked, and advances the processing to step S1009. This is because, in the case of a print job for performing the printing processing using paper that has been designated as the printing order designated paper, there is a possibility that the consistency between the page numbers on the paper that has already been discharged and on the paper that is fed after the printing is resumed cannot be maintained if, the printing is resumed after only removing the paper on the conveying path 401.

Then, the CPU 211 acquires information about paper that currently remains on the conveying path 401 to facilitate the user operation to check the paper feed unit 233 (S1009). In the present embodiment, the CPU 211 determines whether or not the paper information acquired in step S1009 contains special paper with sequentiality (S1301). In other words, the CPU 211 determines whether or not special paper exists on the conveying path 401. Here, if it is determined special paper is not contained, the CPU 211 returns to the printing processing in step S1003 and resumes the stopped printing processing. On the other hand, if it is determined the special paper is contained, the CPU 211 displays a pop-up screen shown in FIG. 12 on the display unit in the operation unit 240 (S1010). The screen shown in FIG. 12 is a screen for prompting the user to open and close the paper feed tray in which the special paper is placed to check the special paper set therein. The user views this screen and arranges the order of the special paper set in the paper feed tray. Specifically, the paper can be arranged so that the paper with a page number that should come after the paper that has already been discharged is at the top in the paper feed tray.

### Other Embodiments

Note that in the above embodiments, an example has been described in which, in step S1010, the CPU 211 displays the screen shown in FIG. 12, thereby displaying the screen for prompting the user to open and close the paper feed tray in which the special paper is placed to check the special paper that is set therein. However, the present invention is not limited thereto. The paper feed trays may be provided with a structure for opening the paper feed trays under the control of the CPU 211, and in step S1010, the CPU 211 may perform control for automatically opening the paper feed tray from which the special paper existing on the conveying path 401 was fed. Thus, the user can more easily adjust the state of special paper set in the paper feed trays. Furthermore, the CPU 211 may perform control so as not to accept a printing resuming instruction until it is detected that the paper feed trays have been opened, or closed after being opened to check the special paper. Thus, the special paper can be prevented from shifting after the printing is resumed. Note that each of the above-described embodiments may be implemented independently, or may be arbitrarily combined for implementation.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-053678, filed Mar. 9, 2012, which is hereby incorporated by reference herein in its entirety.

What is claimed is:

1. A printing apparatus that conveys printing paper via a conveying path and performs printing, comprising:
a detection unit configured to detect a paper jam on the conveying path;
a stop unit configured to stop the printing if the paper jam is detected by the detection unit;
a determination unit configured to determine whether or not predetermined paper with sequentiality exists on the conveying path; and
a control unit configured to wait for an instruction from a user and resume the printing after the paper jam is resolved, if the printing is stopped by the stop unit and it is determined by the determination unit that the predetermined paper with sequentiality exists on the conveying path, and
to resume the printing without waiting for the instruction from the user after the paper jam is resolved, if the printing is stopped by the stop unit and it is determined by the determination unit that the predetermined paper with sequentiality does not exist on the conveying path.

2. The printing apparatus according to claim 1, further comprising a count unit configured to count a number of sheets of fed paper that have been fed to the printing apparatus and a number of sheets of discharged paper that have been discharged from the printing apparatus,
wherein the determination unit determines whether or not the predetermined paper with sequentiality exists based on a difference between the number of sheets of fed paper and the number of sheets of discharged paper, and a type of printing paper used in the printing.

3. The printing apparatus according to claim 1, wherein the predetermined paper with sequentiality is tabbed paper.

4. The printing apparatus according to claim 1,
wherein if the printing is stopped by the stop unit and it is determined by the determination unit that the predetermined paper with sequentiality exists on the conveying path, the control unit automatically opens a paper feed tray from which the predetermined paper with sequentiality is fed.

5. The printing apparatus according to claim 1,
wherein if the printing is stopped by the stop unit and it is determined by the determination unit that the predetermined paper with sequentiality exists on the conveying path, the control unit performs control so as not to accept the instruction from the user until it is detected that the paper feed tray from which the predetermined paper with sequentiality is fed is opened.

6. A method for controlling a printing apparatus that conveys printing paper via a conveying path and performs printing, comprising:
a detection step of detecting a paper jam on the conveying path;
a stop step of stopping the printing if the paper jam is detected in the detection step;
a determination step of determining whether or not predetermined paper with sequentiality exists on the conveying path; and
a control step of waiting for an instruction from a user and resuming the printing after the paper jam is resolved, if the printing is stopped in the stop step and it is determined in the determination step that the predetermined paper with sequentiality exists on the conveying path, and
resuming the printing without waiting for the instruction from the user after the paper jam is resolved, if the printing is stopped in the stop step and it is determined in the determination step that the predetermined paper with sequentiality does not exist on the conveying path.

7. A computer-readable storage medium storing a program for causing a computer to execute:
a detection step of detecting a paper jam on a conveying path;
a stop step of stopping printing if the paper jam is detected in the detection step;
a determination step of determining whether or not predetermined paper with sequentiality exists on the conveying path; and
a control step of waiting for an instruction from a user and resuming the printing after the paper jam is resolved, if the printing is stopped in the stop step and it is determined in the determination step that the predetermined paper with sequentiality exists on the conveying path, and
resuming the printing without waiting for the instruction from the user after the paper jam is resolved, if the printing is stopped in the stop step and it is determined in the determination step that the predetermined paper with sequentiality does not exist on the conveying path.
